(19) United States
(12) Patent Application Publication
(10) Pub. No.: US 2007/0135937 A1
(43) Pub. Date: Jun. 14, 2007

(54) The Rational Transfer Function of a Discrete Control System and Its Linear Quadratic Controllers

(75) Inventor: KY MINH VU, Ottawa, ON (CA)

Correspondence Address: KY MINH VU, 478-2446 Bank Street, Ottawa, ON, K1V 1A8, CA

(73) Assignee: AULAC TECHNOLOGIES INC., Ottawa (CA)

(21) Appl. No.: 11/567,302

(22) Filed: Dec. 6, 2006

(30) Foreign Application Priority Data
Dec. 4, 2005 (CA) 2531710

(51) Int. Cl. G05B 13/02

(52) U.S. Cl. 700/29

(57) ABSTRACT

A rational function for the transfer function model of a multivariable discrete control system is suggested and its controllers are obtained. There are two types of control systems depending on the nature of the disturbance. For tracking control systems, the disturbance is a set of set point changes. For regulating control systems, the disturbance is a vector ARIMA time series. The quadratic performance controllers for these systems are similar but opposite in nature. For tracking control systems, a two and a half degrees of freedom controller can be designed for an enhanced quadratic performance. This controller uses the future values of the disturbance which are the set points of the control system for further reduction of the error. The controller is particularly useful for nonminimum phase tracking control systems.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

1. Field of Invention

This invention relates to control theory and its applications in process control, control of machines and systems. This invention presents a control algorithm that procures a number of controllers for multivariable discrete control systems with a rational transfer function. The controllers have quadratic performance indices.

2. Prior Art

The control of a multivariable control system is a complicated problem. This is due to the fact that it has more variables. And so it does not have a simple and universal model for the derivation of its controllers. As a result no generally accepted quadratic performance controllers have been surfaced. The common approach is the usage of a state space model in the time domain or a polynomial model in the z domain. Even though these models are known and appear in the control literature frequently, the models find their weaknesses in the change of the disturbance. Therefore, one must find a control model simple enough to design controllers but sophisticated enough for different types of disturbance. In the control industry, the usually used controller for a multivariable discrete control system is a Model Predictive Controller (MPC). From the first model of these controllers of Prett, David M. et at. (1982) (“Dynamic Matrix Control Methods”, U.S. Pat. No. 4,349,869) to a number of its variations, these controllers suffer two setbacks of using too many parameters or models that are not general enough and a distorted controller performance index. Naturally, one can see that the control industry is waiting for a controller without these setbacks. In this invention, we will suggest a new model for a multivariable discrete control system with its disturbance models and derive the controllers for the control system. The controllers have quadratic performance indices and are called linear quadratic controllers. The invention is the multivariable version of a previous scalar version invention (The Quadratic Performance, Infinite Steps, Set Point Model Tracking Controllers, U.S. patent application Ser. No. 11,534,102).

3. Objects and Advantages

It is the object of this invention to introduce the rational transfer function for a multivariable control system and obtain the controllers for it for different disturbance models of tracking and regulating controls. There are more than one controller for a particular control system with a particular disturbance model. Each controller is suitable for a particular control system.

It is a further object of this invention to introduce a set point model for an MIMO tracking control system and a VARIMA time series disturbance model for a regulating control system.

It is a further object of this invention to introduce practical and meaningful performance indices for a number of controllers for verification of the system and controller models.

It is a further object of this invention to obtain the equations to calculate the sum of squares or variance of the error or output variable for a comparison with that of other controllers or same controller with other settings of some system parameters and for on-line verification of the control models.

It is a further object of this invention to obtain the equations to calculate the sum of squares or variance for the input variable for a comparison with that of other controllers or same controller with other settings of some system parameters and for on-line verification of the control models.

### SUMMARY

The control algorithm of the new invention is the answer to all current control problems of a multivariable discrete control system. The algorithm is the multivariable or vector version of an earlier control algorithm for scalar systems.

### DRAWINGS

FIG. 1. Block diagram of a control system with its rational transfer function model and disturbance models.

FIG. 2. Block diagram of a feedback tracking control system.

FIG. 3. Block diagram of a feedback regulating control system.

FIG. 4. Block diagram of a controller implementation system.

### DETAILED DESCRIPTION—PREFERRED EMBODIMENT

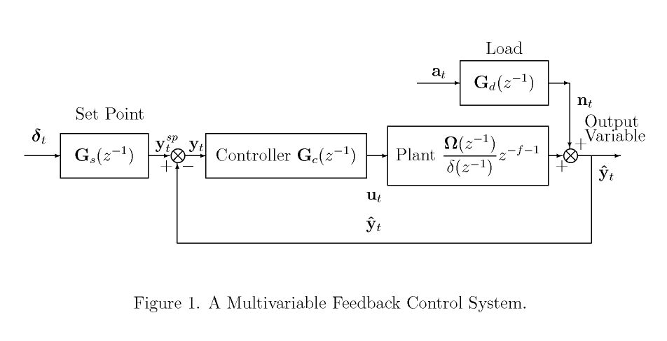

A preferred embodiment of the invention which is described below is the solutions of control systems described by FIGS. 1, 2 and 3.

1 The Transfer Function Model

For a single input single output (SISO) control system, the Box-Jenkins model is a well known model for stochastic regulating control systems. The model has the attraction that it is a parsimonious model and it separates the disturbance to show duality of tracking and regulating controls. The model uses a rational transfer function. The multivariable rational transfer function for a multivariable control system can be given below.

$${\hat{y}}_{t} = \frac{Ω ( {z}^{- 1} )}{δ ( {z}^{- 1} )} {z}^{- f - 1} {u}_{t} . \qquad ( 1 )$$

The polynomial Ω(z⁻¹) is a matrix polynomial and the polynomial δ(z⁻¹) is a scalar polynomial. The integer f is the pure dead time of the model. The variables ŷₜ and uₜ are vectors of the output and input variables of possible different dimensions. When the polynomial Ω(z⁻¹) is a scalar polynomial, the system is an SISO control system. Other models can be converted to this model easily. For example, the state space model

$$\begin{matrix}{x}_{t + 1} = {Ax}_{t} + {bu}_{t - f} , \\ {\hat{y}}_{t} = {cx}_{t}\end{matrix}$$

can be put to the model represented by Eq. 1 as follows

$$\begin{matrix}{\hat{y}}_{t} = \frac{{c [ I - A {z}^{- 1} ]}^{+} b}{\vert I - A {z}^{- 1} \vert} {u}_{t - f - 1} , \\ = \frac{Ω ( {z}^{- 1} )}{δ ( {z}^{- 1} )} {z}^{- f - 1} {u}_{t} .\end{matrix}$$

Similarly the polynomial model of the system

$$\begin{matrix}a ( {z}^{- 1} ) {\hat{y}}_{t} = b ( {z}^{- 1} ) {u}_{t - f - 1} , \\ ( I - {a}_{1} {z}^{- 1} - {a}_{2} {z}^{- 2} - … ) {\hat{y}}_{t} = ( {b}_{0} - {b}_{1} {z}^{- 1} - {b}_{2} {z}^{- 2} - … ) {u}_{t - f - 1}\end{matrix}$$

can be put to the state space model

$$\begin{matrix}{x}_{t + 1} = [ \begin{matrix}{a}_{1} & \\ {a}_{2} & I \\ {a}_{3} & \\ ⋮ & …\end{matrix} ] {x}_{t} + [ \begin{matrix}{b}_{0} \\ - {b}_{1} \\ - {b}_{2} \\ ⋮\end{matrix} ] {u}_{t - f} , \\ {\hat{y}}_{t} = [ \begin{matrix}I & … & 0 & …\end{matrix} ] {x}_{t}\end{matrix}$$

and then the model represented by Eq. 1 as above. Therefore, the transfer function model represented by this equation can serve as a general transfer function model for all multivariable linear control systems.

2 The Deterministic Tracking Control Systems

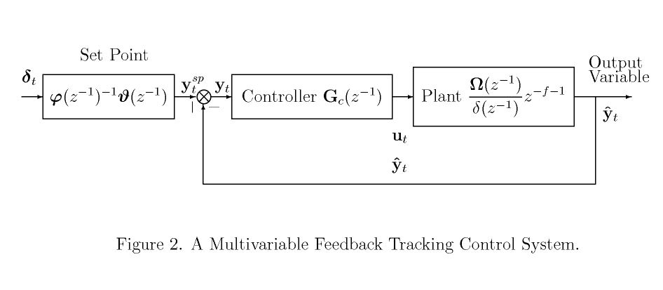

A feedback control system will have the structure described by FIG. 1. If the control system is a tracking control system, the disturbance is a set point change. Therefore, we have a control system as in FIG. 2 and we need a model for the set point variable yₜ^{sp}.

2.1 The Set Point Model

A poor practice in tracking controller design is the lack of a set point model. The change is almost always assumed as a step change and certain requirement, eg. unity gain of the closed loop transfer function for the new set point be reached. For a multiple set point change of a multivariable control system, the following model can be used:
φ(z⁻¹)yₜ^{sp}=ν(z⁻¹)δₜ,
φ*(z⁻¹)∇^{d}(z⁻¹)yₜ^{sp}=ν(z⁻¹)δₜ. (2)

For a meaningful value of a set point model, the polynomials ∇^{d}(z⁻¹), φ*(z⁻¹) and ν(z⁻¹) consist of square and diagonal matrices. The polynomial ∇^{d}(z⁻¹) is a polynomial of difference factors (1−z⁻¹)^{d}. The determinants of the polynomials φ*(z⁻¹) and ν(z⁻¹) have all the zeros with modulus greater than one. For tracking control the vector δₜ is a Dirac vector sequence with value of r for one set point change period. The constants of this vector serve the purpose of scaling up or down the set point change values.

The multivariable feedback tracking control system with its transfer function and set point model is depicted in the FIG. 2. From the this figure, we can write the offset or error variable vector of the control system as below

$$\begin{matrix}{y}_{t} = - {\hat{y}}_{t} + {y}_{t}^{sp} , \\ = - \frac{Ω ( {z}^{- 1} )}{δ ( {z}^{- 1} )} {z}^{- f - 1} {u}_{t} + {[ {φ}^{*} ( {z}^{- 1} ) {∇}^{d} ( {z}^{- 1} ) ]}^{- 1} ϑ ( {z}^{- 1} ) {δ}_{t} , \\ = - \frac{Ω ( {z}^{- 1} )}{δ ( {z}^{- 1} )} {z}^{- f - 1} {u}_{t} + \frac{{[ {φ}^{*} ( {z}^{- 1} ) {∇}^{d} ( {z}^{- 1} ) ]}^{+}}{\vert {φ}^{*} ( {z}^{- 1} ) \vert \vert {∇}^{d} ( {z}^{- 1} ) \vert} ϑ ( {z}^{- 1} ) {δ}_{t} .\end{matrix} \qquad ( 3 )$$

By defining the following Diophantine equation

$$\frac{{[ {φ}^{*} ( {z}^{- 1} ) {∇}^{d} ( {z}^{- 1} ) ]}^{+} ϑ ( {z}^{- 1} )}{\vert {φ}^{*} ( {z}^{- 1} ) \vert \vert {∇}^{d} ( {z}^{- 1} ) \vert} = ψ ( {z}^{- 1} ) + \frac{γ ( {z}^{- 1} )}{\vert {φ}^{*} ( {z}^{- 1} ) \vert \vert {∇}^{d} ( {z}^{- 1} ) \vert} {z}^{- f - 1} , \qquad ( 4 )$$

we can write the system model as below

$$\begin{matrix}{y}_{t} = - \frac{Ω ( {z}^{- 1} )}{δ ( {z}^{- 1} )} {z}^{- f - 1} {u}_{t} + \frac{{[ {φ}^{*} ( {z}^{- 1} ) {∇}^{d} ( {z}^{- 1} ) ]}^{+}}{\vert {φ}^{*} ( {z}^{- 1} ) \vert \vert {∇}^{d} ( {z}^{- 1} ) \vert} ϑ ( {z}^{- 1} ) {δ}_{t} , \\ = - \frac{Ω ( {z}^{- 1} )}{δ ( {z}^{- 1} )} {z}^{- f - 1} {u}_{t} + ψ ( {z}^{- 1} ) {δ}_{t} + \frac{γ ( {z}^{- 1} )}{\vert {φ}^{*} ( {z}^{- 1} ) \vert \vert {∇}^{d} ( {z}^{- 1} ) \vert} {z}^{- f - 1} {δ}_{t} , \\ = ψ ( {z}^{- 1} ) {δ}_{t} - [ \frac{Ω ( {z}^{- 1} )}{δ ( {z}^{- 1} )} {u}_{t} - \frac{γ ( {z}^{- 1} )}{\vert {φ}^{*} ( {z}^{- 1} ) \vert \vert {∇}^{d} ( {z}^{- 1} ) \vert} {δ}_{t} ] {z}^{- f - 1} .\end{matrix} \qquad ( 5 )$$

With the model of the control system established, now we can proceed to obtain the controllers for it.

2.2 The Tracking Controllers

There are three controllers that we can obtain. They are the output deadbeat, the one degree of freedom (1-DOF) and two and a half degrees of freedom (2.5-DOF) linear quadratic controllers.

2.2.1 The Minimal Prototype Output Deadbeat Controller

The minimal prototype output deadbeat controller is the simplest controller, so we will obtain it first. It will give us revelation to the form of other controllers. To obtain the output deadbeat controller we set the second term in Eq. (5) above to zero, because by doing so the error will be zero after the dead time of the system. And we have

$$\begin{matrix}\frac{Ω ( {z}^{- 1} )}{δ ( {z}^{- 1} )} {u}_{t} = \frac{γ ( {z}^{- 1} )}{\vert {φ}^{*} ( {z}^{- 1} ) \vert \vert {∇}^{d} ( {z}^{- 1} ) \vert} {δ}_{t} , \\ \frac{Ω ( {z}^{- 1} )}{δ ( {z}^{- 1} )} \vert {∇}^{d} ( {z}^{- 1} ) \vert {u}_{t} = \frac{γ ( {z}^{- 1} )}{\vert {φ}^{*} ( {z}^{- 1} ) \vert} {δ}_{t} , \\ {y}_{t} = ψ ( {z}^{- 1} ) {δ}_{t} .\end{matrix}$$

From the above equations, we can derive the equation for the controller in an implementable form as follows.

$$\frac{Ω ( {z}^{- 1} )}{δ ( {z}^{- 1} )} \vert {∇}^{d} ( {z}^{- 1} ) \vert {u}_{t} = \frac{γ ( {z}^{- 1} )}{\vert {φ}^{*} ( {z}^{- 1} ) \vert} {ψ ( {z}^{- 1} )}^{- 1} {y}_{t} \\ or \\ \vert {φ}^{*} ( {z}^{- 1} ) \vert \vert ψ ( {z}^{- 1} ) \vert Ω ( {z}^{- 1} ) \vert {∇}^{d} ( {z}^{- 1} ) \vert {u}_{t} = δ ( {z}^{- 1} ) γ ( {z}^{- 1} ) {ψ ( {z}^{- 1} )}^{+} {y}_{t} . \qquad ( 6 )$$

For performance verification, we can define and calculate the following quantities:

$$\begin{matrix}{R}_{y , MP} = {\sum }_{t = 0}^{∞} {y}_{t} {y}_{t}^{T} , \\ = {Residue}_{z = 0} ψ ( z ) r {r}^{T} {ψ ( {z}^{- 1} )}^{T} \frac{1}{z}\end{matrix} \qquad ( 7 )$$

and if Ω(z⁻¹) is square and invertible

$$\begin{matrix}{R}_{\vert {∇}^{d} \vert u , MP} = {\sum }_{t = 0}^{∞} \vert {∇}^{d} ( {z}^{- 1} ) \vert {u}_{t} \vert {∇}^{d} ( {z}^{- 1} ) \vert {u}_{t}^{T} , \\ = {Residue}_{z = 0} \frac{δ ( z ) {Ω ( z )}^{+} γ ( z ) {rr}^{T} {γ ( {z}^{- 1} )}^{T} {Ω ( {z}^{- 1} )}^{{+}^{T}} δ ( {z}^{- 1} )}{z \vert {φ}^{*} ( z ) \vert \vert Ω ( z ) \vert \vert Ω ( {Z}^{- 1} ) \vert \vert {φ}^{*} ( {z}^{- 1} ) \vert} .\end{matrix} \qquad ( 8 )$$

These quantities can be calculated theoretically and from the data. If they match with their counterparts, the model of the system is exact and the controller's performance is as desired.

2.2.2 The 1-DOF Linear Quadratic Controller

The output deadbeat controller is criticized for its high gain and so occasionally controllers are designed to constrain the movement of the input variable. These controllers are called the Linear Quadratic (LQ) tracking controllers. And there are situations when one cannot design an output deadbeat controller. A typical case is when a control system has a nonminimum phase. Therefore, we need to design an LQ controller. The performance index of a multivariable LQ controller is

$$\begin{matrix}{\hat{σ}}^{2} = Min {σ}^{2} , \\ = Min tr {\sum }_{t = 0}^{∞} {Q}_{1} {y}_{t} {y}_{t}^{T} + {Q}_{2} \vert ∇ {( {z}^{- 1} )}^{d} \vert {u}_{t} \vert ∇ {( {z}^{- 1} )}^{d} \vert {u}_{t}^{T} .\end{matrix} \qquad ( 9 )$$

Note that even though this is a multivariable system, the performance index is a scalar. The choices for the matrices Q₁ and Q₂ are usually diagonal matrices with appropriate dimensions and positive terms. The matrix Q₁ is usually chosen to be an identity matrix, unless there are reasons for having different weightings for the components of the output variable vector. The matrix Q₂ is a penalty matrix. Each coefficient on the main diagonal of this matrix is a penalty on a particular component of the input variable vector. A larger number means more penalty and the result will be a smaller variance of this component. However, this will increase the variances of the output variable components that it affects. In the case the terms off the main diagonal of this matrix are not zero, the controller also restricts the cross-covariation of the input components. If these terms are nonzero, one has to ascertain that the matrix Q₂ is positive definite.

Since the source of change is the variable δₜ, we will write the controller in term of this variable. Assuming that the control actions is a linear combination of the current and past values of this variable, we write
|∇^{d}(z⁻¹)|uₜ=1(z⁻¹)δₜ.

For an infinite steps control algorithm, we define the following one sided z transform:

$$\begin{matrix}y ( {z}^{- 1} ) = ℨ \{ {y}_{t} \} , \\ = {\sum }_{t = 0}^{∞} {y}_{t} {z}^{- t} ,\end{matrix}$$

$$u ( {z}^{- 1} ) = {\sum }_{t = 0}^{∞} {u}_{t} {z}^{- t} .$$

The z transform of δₜ will simply be the vector r and this means that we can write

$$y ( {z}^{- 1} ) = ψ ( {z}^{- 1} ) r - [ \frac{Ω ( {z}^{- 1} ) l ( {z}^{- 1} )}{δ ( {z}^{- 1} ) \vert {∇}^{d} ( {z}^{- 1} ) \vert} - \frac{γ ( {z}^{- 1} )}{\vert {φ}^{*} ( {z}^{- 1} ) \vert \vert {∇}^{d} ( {z}^{- 1} ) \vert} ] {z}^{- f - 1} r .$$

Therefore we can say that

$$\begin{matrix}{\sum }_{t = 0}^{∞} {y}_{t} {y}_{t}^{T} = {Residue}_{z = 0} y ( z ) r {r}^{T} {y ( {z}^{- 1} )}^{T} \frac{1}{z} , \\ = {Residue}_{z = 0} [ ψ ( z ) - [ \frac{Ω ( z ) l ( z )}{δ ( z ) \vert {∇}^{d} ( z ) \vert} - \frac{γ ( z )}{\vert {φ}^{*} ( z ) \vert \vert {∇}^{d} ( z ) \vert} ] {z}^{f + 1} ] {rr}^{T}\end{matrix} \\ [ ψ ( {z}^{- 1} ) - [ \frac{Ω ( {z}^{- 1} ) l ( {z}^{- 1} )}{δ ( {z}^{- 1} ) \vert {∇}^{d} ( {z}^{- 1} ) \vert} - \frac{γ ( {z}^{- 1} )}{\vert {φ}^{*} ( {z}^{- 1} ) \vert \vert {∇}^{d} ( {z}^{- 1} ) \vert} ] {{z}^{- f - 1}}^{T} ] \frac{1}{z} .$$

With the above result, we can write the performance index as below

$${σ}^{2} = t r {Residue}_{z = 0} {Q}_{1} [ ψ ( z ) - [ \frac{Ω ( z ) l ( z )}{δ ( z ) \vert {∇}^{d} ( z ) \vert} - \frac{γ ( z )}{\vert {φ}^{*} ( z ) \vert \vert {∇}^{d} ( z ) \vert} ] {z}^{f + 1} ] r {{r}^{T} [ ψ ( {z}^{- 1} ) - [ \frac{Ω ( {z}^{- 1} ) l ( {z}^{- 1} )}{δ ( {z}^{- 1} ) \vert {∇}^{d} ( {z}^{- 1} ) \vert} - \frac{γ ( {z}^{- 1} )}{\vert {φ}^{*} ( {z}^{- 1} ) \vert \vert {∇}^{d} ( {z}^{- 1} ) \vert} ] {z}^{- f - 1} ]}^{T} \frac{1}{z} + t r {Residue}_{z = 0} {Q}_{2} l ( z ) r {r}^{T} {l ( {z}^{- 1} )}^{T} \frac{1}{z} . \\ or$$

$${σ}^{2} = {Residue}_{z = 0} t r \{ {Q}_{1} ψ ( z ) r {r}^{T} {ψ ( {z}^{- 1} )}^{T} + {Q}_{1} [ \frac{Ω ( z ) l ( z )}{δ ( z ) \vert {∇}^{d} ( z ) \vert} - \frac{γ ( z )}{\vert {φ}^{*} ( z ) \vert \vert {∇}^{d} ( z ) \vert} ] r {r}^{T} [ \frac{{l ( {z}^{- 1} )}^{T} {Ω ( {z}^{- 1} )}^{T}}{δ ( {z}^{- 1} ) \vert {∇}^{d} ( {z}^{- 1} ) \vert} - \frac{{γ ( {z}^{- 1} )}^{T}}{\vert {φ}^{*} ( {z}^{- 1} ) \vert \vert {∇}^{d} ( {z}^{- 1} ) \vert} ] + {Q}_{2} \frac{δ ( z ) \vert {∇}^{d} ( z ) \vert l ( z ) r {r}^{T} {l ( {z}^{- 1} )}^{T} δ ( {z}^{- 1} ) \vert {∇}^{d} ( {z}^{- 1} ) \vert}{δ ( z ) \vert {∇}^{d} ( z ) \vert δ ( {z}^{- 1} ) \vert {∇}^{d} ( {z}^{- 1} ) \vert} \} \frac{1}{z} .$$

By expanding the second term of the equation, we obtain

$${σ}^{2} = {Residue}_{z = 0} t r \{ {Q}_{1} ψ ( z ) r {r}^{T} {ψ ( {z}^{- 1} )}^{T} + {Q}_{1} \frac{γ ( z ) r {r}^{T} {γ ( {z}^{- 1} )}^{T}}{\vert {φ}^{*} ( z ) \vert \vert {∇}^{d} ( z ) \vert \vert {φ}^{*} ( {z}^{- 1} ) \vert \vert {∇}^{d} ( {z}^{- 1} ) \vert} + {Q}_{1} \frac{Ω ( z ) l ( z ) r {r}^{T} {l ( {z}^{- 1} )}^{T} {Ω ( {z}^{- 1} )}^{T}}{δ ( z ) \vert {∇}^{d} ( z ) \vert δ ( {z}^{- 1} ) \vert {∇}^{d} ( {z}^{- 1} ) \vert} - {Q}_{1} \frac{γ ( z ) r {r}^{T} {l ( {z}^{- 1} )}^{T} {Ω ( {z}^{- 1} )}^{T}}{\vert {φ}^{*} ( z ) \vert \vert {∇}^{d} ( z ) \vert δ ( {z}^{- 1} ) \vert {∇}^{d} ( {z}^{- 1} ) \vert} - {Q}_{1} \frac{Ω ( z ) l ( z ) r {r}^{T} {γ ( {z}^{- 1} )}^{T}}{δ ( z ) \vert {∇}^{d} ( z ) \vert \vert {φ}^{*} ( {z}^{- 1} ) \vert \vert {φ}^{*} ( {z}^{- 1} ) \vert \vert {∇}^{d} ( {z}^{- 1} ) \vert} + {Q}_{2} \frac{δ ( z ) \vert {∇}^{d} ( z ) \vert l ( z ) r {r}^{T} {l ( {z}^{- 1} )}^{T} δ ( {z}^{- 1} ) \vert {∇}^{d} ( {z}^{- 1} ) \vert}{δ ( z ) \vert {∇}^{d} ( z ) \vert δ ( {z}^{- 1} ) \vert {∇}^{d} ( {z}^{- 1} ) \vert} \} \frac{1}{z} .$$

Now by using a characteristic of the trace of matrix theory, we can write the previous equation as below

$${σ}^{2} = {Residue}_{z = 0} t r \{ {Q}_{1} ψ ( z ) r {r}^{T} {ψ ( {z}^{- 1} )}^{T} + r {r}^{T} \frac{{γ ( {z}^{- 1} )}^{T} {Q}_{1} γ ( z )}{\vert {φ}^{*} ( {z}^{- 1} ) \vert \vert {∇}^{d} ( {z}^{- 1} ) \vert \vert {φ}^{*} ( z ) \vert \vert {∇}^{d} ( z ) \vert} + r {r}^{T} \frac{{l ( {z}^{- 1} )}^{T} {Ω ( {z}^{- 1} )}^{T} {Q}_{1} Ω ( z ) l ( z )}{δ ( {z}^{- 1} ) \vert {∇}^{d} ( {z}^{- 1} ) \vert δ ( z ) \vert {∇}^{d} ( z ) \vert} - r {r}^{T} \frac{{l ( {z}^{- 1} )}^{T} {Ω ( {z}^{- 1} )}^{T} {Q}_{1} γ ( z )}{δ ( {z}^{- 1} ) \vert {∇}^{d} ( {z}^{- 1} ) \vert \vert {φ}^{*} ( z ) \vert \vert {∇}^{d} ( z ) \vert} - r {r}^{T} \frac{{γ ( {z}^{- 1} )}^{T} {Q}_{1} Ω ( z ) l ( z )}{\vert {φ}^{*} ( {z}^{- 1} ) \vert \vert {∇}^{d} ( {z}^{- 1} ) \vert δ ( z ) \vert {∇}^{d} ( z ) \vert} + r {r}^{T} \frac{{l ( {z}^{- 1} )}^{T} \vert {∇}^{d} ( {z}^{- 1} ) \vert δ ( {z}^{- 1} ) {Q}_{2} δ ( z ) \vert {∇}^{d} ( z ) \vert l ( z )}{δ ( {z}^{- 1} ) \vert {∇}^{d} ( {z}^{- 1} ) \vert δ ( z ) \vert {∇}^{d} ( z ) \vert} \} \frac{1}{z} .$$

Now we define the following matrix spectral factorization equation:
α(z⁻¹)^{T}α(z)=Ω(z⁻¹)^{T}Q₁Ω(z)+|∇^{d}(z⁻¹)|δ(z⁻¹)Q₂δ(z)|∇^{d}(z)| (10)
and
π(z)π(z⁻¹)^{T}=\sqrt{Q₀}Ω*(z)Q₂⁻¹Ω*(z⁻¹)^{T}\sqrt{Q₀}+|∇^{d}(z)|δ(z)Q₀δ(z⁻¹)|∇^{d}(z⁻¹)|. (11)

The matrix Q₀ is a square matrix with dimension of the matrix Q₁ but magnitude of the matrix Q₂. With these definitions, we can write the performance index as below

$${σ}^{2} = {Residue}_{z = 0} t r \{ {Q}_{1} ψ ( z ) r {r}^{T} {ψ ( {z}^{- 1} )}^{T} + \frac{δ ( z ) {π ( z )}^{+} \sqrt{{Q}_{0}} \sqrt{{Q}_{1}} γ ( z ) r {r}^{T} γ ( {z}^{- 1} ) {γ ( {z}^{- 1} )}^{T} \sqrt{{Q}_{1}} \sqrt{{Q}_{0}} {π ( {z}^{- 1} )}^{{T}^{+}} δ ( {z}^{- 1} )}{\vert {φ}^{*} ( z ) \vert \vert π ( z ) \vert \vert {φ}^{*} ( {z}^{- 1} ) \vert \vert π ( {z}^{- 1} ) \vert} + r {r}^{T} [ \frac{{l ( {z}^{- 1} )}^{T} {α ( {z}^{- 1} )}^{T}}{δ ( {z}^{- 1} ) \vert {∇}^{d} ( {z}^{- 1} ) \vert} - \frac{{γ ( {z}^{- 1} )}^{T} {Q}_{1} Ω ( z ) {α ( z )}^{+}}{\vert {φ}^{*} ( {z}^{- 1} ) \vert \vert {∇}^{d} ( {z}^{- 1} ) \vert \vert α ( z ) \vert} ] [ \frac{α ( z ) l ( z )}{δ ( z ) \vert {∇}^{d} ( z ) \vert} - \frac{{α ( {z}^{- 1} )}^{{T}^{+}} {Ω ( {z}^{- 1} )}^{T} {Q}_{1} γ ( z )}{\vert α ( {z}^{- 1} ) \vert \vert {φ}^{*} ( z ) \vert \vert {∇}^{d} ( z ) \vert} ] \} \frac{1}{z} . \qquad ( 12 )$$

To obtain the one degree of freedom (1-DOF) LQ controller, we can define the following spectral separation Diophantine equation:

$$\frac{{γ ( {z}^{- 1} )}^{T} {Q}_{1} Ω ( z ) {α ( z )}^{+}}{\vert φ * ( {z}^{- 1} ) \vert \vert {∇}^{d} ( {z}^{- 1} ) \vert \vert α ( z ) \vert} = \frac{{β}_{1} ( {z}^{- 1} )}{\vert φ * ( {z}^{- 1} ) \vert \vert {∇}^{d} ( {z}^{- 1} ) \vert} + \frac{{ζ}_{1} ( z )}{\vert α ( z ) \vert} z \qquad ( 13 )$$

and obtain this controller as below

$$1 ( {z}^{- 1} ) = \frac{δ ( {z}^{- 1} ) {α ( {z}^{- 1} )}^{+} {β}_{1} ( {z}^{- 1} )}{\vert α ( {z}^{- 1} ) \vert \vert φ * ( {z}^{- 1} ) \vert} .$$

From this controller we can write

$$\vert {∇}^{d} ( {z}^{- 1} ) \vert {u}_{t} = \frac{δ ( {z}^{- 1} ) {α ( {z}^{- 1} )}^{+} {β}_{1} ( {z}^{- 1} )}{\vert α ( {z}^{- 1} ) \vert \vert φ * ( {z}^{- 1} ) \vert} {δ}_{t}$$

and obtain the sum of the squared values of the input variable as below

$$\begin{matrix}{R}_{\vert {∇}^{d} \vert u , 1 - DOF} = {\sum }_{t = 0}^{∞} \vert {∇}^{d} ( {z}^{- 1} ) \vert {u}_{t} \vert {∇}^{d} ( {z}^{- 1} ) \vert {u}_{t}^{T} , \\ = {Residue}_{z = 0} \frac{δ ( z ) {α ( z )}^{+} {β}_{1} ( z ) {rr}^{T} {{β}_{1} ( {z}^{- 1} )}^{T} {α ( {z}^{- 1} )}^{{+}^{T}} δ ( {z}^{- 1} )}{z \vert α ( z ) \vert \vert φ * ( z ) \vert \vert α ( {z}^{- 1} ) \vert \vert φ * ( {z}^{- 1} ) \vert} .\end{matrix} \qquad ( 14 )$$

To obtain a similar quantity for the error variable, we write

$$\begin{matrix}{y}_{t} = ψ ( {z}^{- 1} ) {δ}_{t} + \frac{γ ( {z}^{- 1} ) {z}^{- f - 1}}{\vert φ * ( {z}^{- 1} ) \vert \vert {∇}^{d} ( {z}^{- 1} ) \vert} {δ}_{t} - \\ \frac{Ω ( {z}^{- 1} )}{δ ( {z}^{- 1} )} \frac{δ ( {z}^{- 1} ) {α ( {z}^{- 1} )}^{+} {β}_{1} ( {z}^{- 1} ) {z}^{- f - 1}}{\vert α ( {z}^{- 1} ) \vert \vert φ * ( {z}^{- 1} ) \vert \vert {∇}^{d} ( {z}^{- 1} ) \vert} {δ}_{t} , \\ = ψ ( {z}^{- 1} ) {δ}_{t} + \frac{\vert α ( {z}^{- 1} ) \vert γ ( {z}^{- 1} ) - Ω ( {z}^{- 1} ) {α ( {z}^{- 1} )}^{+} {β}_{1} ( {z}^{- 1} )}{\vert α ( {z}^{- 1} ) \vert \vert φ * ( {z}^{- 1} ) \vert \vert {∇}^{d} ( {z}^{- 1} ) \vert} {z}^{- f - 1} {δ}_{t} , \\ = ψ ( {z}^{- 1} ) {δ}_{t} + \frac{\vert {∇}^{d} ( {z}^{- 1} ) \vert η ( {z}^{- 1} )}{\vert α ( {z}^{- 1} ) \vert \vert φ * ( {z}^{- 1} ) \vert \vert {∇}^{d} ( {z}^{- 1} ) \vert} {z}^{- f - 1} {δ}_{t} , \\ = ψ ( {z}^{- 1} ) {δ}_{t} + \frac{η ( {z}^{- 1} )}{\vert α ( {z}^{- 1} ) \vert \vert φ * ( {z}^{- 1} ) \vert} {z}^{- f - 1} {δ}_{t} .\end{matrix}$$

And we have

$$\begin{matrix}{R}_{y , 1 - DOF} = {\sum }_{t = 0}^{∞} {y}_{t} {y}_{t}^{T} , \\ = {Residue}_{z = 0} \{ \begin{matrix}ψ ( z ) {rr}^{T} {ψ ( {z}^{- 1} )}^{T} + \\ \frac{η ( z ) {rr}^{T} {η ( {z}^{- 1} )}^{T}}{\vert α ( z ) \vert \vert φ * ( z ) \vert \vert α ( {z}^{- 1} ) \vert \vert φ * ( {z}^{- 1} ) \vert}\end{matrix} \} \frac{1}{z} .\end{matrix} \qquad ( 15 )$$

The performance index for this controller is given by the following equation:

$${\hat{σ}}_{1 - DOF}^{2} = {Residue}_{z = 0} \{ \begin{matrix}ψ ( z ) {rr}^{T} {ψ ( {z}^{- 1} )}^{T} + \frac{{{ζ}_{1} ( z )}^{T} {rr}^{T} {ζ}_{1} ( {z}^{- 1} )}{\vert α ( z ) \vert \vert α ( {z}^{- 1} ) \vert} + \\ \frac{( δ ( z ) {π ( z )}^{+} \sqrt{{Q}_{0}} \sqrt{{Q}_{1}} γ ( z ) {rr}^{T} {γ ( {z}^{- 1} )}^{T} \sqrt{{Q}_{1}} \sqrt{{Q}_{0}} {π ( {z}^{- 1} )}^{T +} δ ( {z}^{- 1} ) )}{( \vert φ * ( z ) \vert \vert π ( z ) \vert \vert φ * ( {z}^{- 1} ) \vert \vert λ ( {z}^{- 1} ) \vert )}\end{matrix} \} \frac{1}{z} . \qquad ( 16 )$$

To obtain the controller in terms of the input and error variables, we write the following equations:

$$\frac{α ( {z}^{- 1} ) 1 ( {z}^{- 1} )}{δ ( {z}^{- 1} ) \vert {∇}^{d} ( {z}^{- 1} ) \vert} {δ}_{t} = \frac{{β}_{1} ( {z}^{- 1} )}{\vert φ * ( {z}^{- 1} ) \vert \vert {∇}^{d} ( {z}^{- 1} ) \vert} {δ}_{t} , \\ \frac{α ( {z}^{- 1} )}{δ ( {z}^{- 1} )} = \frac{{β}_{1} ( {z}^{- 1} )}{\vert φ * ( {z}^{- 1} ) \vert \vert {∇}^{d} ( {z}^{- 1} ) \vert} \frac{{ϑ ( {z}^{- 1} )}^{+} φ * ( {z}^{- 1} ) {∇}^{d} ( {z}^{- 1} )}{\vert ϑ ( {z}^{- 1} ) \vert} [ {\hat{y}}_{t} + {y}_{t} ] .$$

By replacing the variable ŷₜ for the input variable uₜ, we can write the above equation as

$$[ \frac{α ( {z}^{- 1} )}{δ ( {z}^{- 1} )} - \frac{{β}_{1} ( {z}^{- 1} ) {ϑ ( {z}^{- 1} )}^{+} φ * ( {z}^{- 1} ) {∇}^{d} ( {z}^{- 1} ) Ω ( {z}^{- 1} ) {z}^{- f - 1}}{\vert φ * ( {z}^{- 1} ) \vert \vert {∇}^{d} ( {z}^{- 1} ) \vert \vert ϑ ( {z}^{- 1} ) \vert δ ( {z}^{- 1} )} ] {u}_{t} = \frac{{β}_{1} ( {z}^{- 1} ) {ϑ ( {z}^{- 1} )}^{+} φ * ( {z}^{- 1} ) {∇}^{d} ( {z}^{- 1} )}{\vert φ * ( {z}^{- 1} ) \vert \vert {∇}^{d} ( {z}^{- 1} ) \vert \vert ϑ ( {z}^{- 1} ) \vert} {y}_{t} \\ or \\ [ \begin{matrix}\vert ϑ ( {z}^{- 1} ) \vert \vert φ * ( {z}^{- 1} ) \vert \vert {∇}^{d} ( {z}^{- 1} ) \vert α ( {z}^{- 1} ) - \\ {β}_{1} ( {z}^{- 1} ) {ϑ ( {z}^{- 1} )}^{+} φ * ( {z}^{- 1} ) {∇}^{d} ( {z}^{- 1} ) Ω ( {z}^{- 1} ) {z}^{- f - 1}\end{matrix} ] {u}_{t} = δ ( {z}^{- 1} ) {β}_{1} ( {z}^{- 1} ) {ϑ ( {z}^{- 1} )}^{+} φ * ( {z}^{- 1} ) {∇}^{d} ( {z}^{- 1} ) {y}_{t} . \qquad ( 17 )$$

2.2.3 The 2.5-DOF Linear Quadratic Controller

The two and a half degrees of freedom (2.5-DOF) LQ controller is designed to improve the performance index of the 1-DOF controller. Now we assume that the controller is a linear combination of past, current and future values of the variable δₜ, ie. we have
|∇^{d}(z⁻¹)|uₜ=1(z⁻¹, z)δₜ.

To derive this controller, we need to use the two sided z transform and so we will define the following equations:

$$\begin{matrix}y ( {z}^{- 1} ) = 𝒵 \{ {y}_{t} \} , \\ = {\sum }_{t = - ∞}^{∞} {y}_{t} {z}^{- t} ,\end{matrix}$$

$$u ( {z}^{- 1} ) = {\sum }_{t = - ∞}^{∞} {u}_{t} {z}^{- t} .$$

With these definitions, we must have the following performance index value:

$$\begin{matrix}{\hat{σ}}^{2} = Min {σ}^{2} , \\ = Min tr {\sum }_{t = - ∞}^{∞} {Q}_{1} {y}_{t} {y}_{t}^{T} + {Q}_{2} \vert ∇ {( {z}^{- 1} )}^{d} \vert {u}_{t} \vert ∇ {( {z}^{- 1} )}^{d} \vert {u}_{t}^{T} .\end{matrix} \qquad ( 18 )$$

And from the above controller equation form, we can obtain the performance index equation similar to Eq. (12) as below

$${σ}^{2} = {Residue}_{z = 0} tr \{ {Q}_{1} ψ ( z ) {rr}^{T} {ψ ( {z}^{- 1} )}^{T} + \frac{δ ( z ) {π ( z )}^{+} \sqrt{{Q}_{0}} \sqrt{{Q}_{1}} γ ( z ) {rr}^{T} {γ ( {z}^{- 1} )}^{T} \sqrt{{Q}_{1}} \sqrt{{Q}_{0}} {π ( {z}^{- 1} )}^{T +} δ ( {z}^{- 1} )}{\vert φ * ( z ) \vert \vert π ( z ) \vert \vert φ * ( {z}^{- 1} ) \vert \vert π ( {z}^{- 1} ) \vert} + {rr}^{T} [ \frac{1 {( {z}^{- 1} , z )}^{T} {α ( {z}^{- 1} )}^{T}}{δ ( {z}^{- 1} ) \vert {∇}^{d} ( {z}^{- 1} ) \vert} - \frac{{γ ( {z}^{- 1} )}^{T} {Q}_{1} Ω ( z ) {α ( z )}^{+}}{\vert φ * ( {z}^{- 1} ) \vert \vert {∇}^{d} ( {z}^{- 1} ) \vert \vert α ( z ) \vert} ] \\ [ \frac{α ( z ) 1 ( z , {z}^{- 1} )}{δ ( z ) \vert {∇}^{d} ( z ) \vert} - \frac{{α ( {z}^{- 1} )}^{T} + Ω ( {z}^{- 1} ) {Q}_{1} γ ( z )}{\vert α ( {z}^{- 1} ) \vert \vert φ * ( z ) \vert \vert {∇}^{d} ( z ) \vert} ] \} \frac{1}{z} .$$

To obtain the controller, we set the last term of the performance index equation to zero, ie. we have

$${\hat{σ}}_{2.5 - DOF}^{2} = {Residue}_{z = 0} tr \\ \{ \begin{matrix}{Q}_{1} ψ ( z ) {rr}^{T} {ψ ( {z}^{- 1} )}^{T} + \\ \frac{δ ( z ) {π ( z )}^{+} \sqrt{{Q}_{0}} \sqrt{{Q}_{1}} γ ( z ) {rr}^{T} {γ ( {z}^{- 1} )}^{T} \sqrt{{Q}_{1}} \sqrt{{Q}_{0}} {π ( {z}^{- 1} )}^{T +} δ ( {z}^{- 1} )}{\vert φ * ( z ) \vert \vert π ( z ) \vert \vert φ * ( {z}^{- 1} ) \vert \vert π ( {z}^{- 1} ) \vert}\end{matrix} \} \frac{1}{z} \qquad ( 19 )$$

and we have

$$\frac{α ( {z}^{- 1} ) 1 ( {z}^{- 1} )}{δ ( {z}^{- 1} ) \vert {∇}^{d} ( {z}^{- 1} ) \vert} = \frac{{α ( z )}^{T +} {Ω ( z )}^{T} {Q}_{1} γ ( {z}^{- 1} )}{\vert φ * ( {z}^{- 1} ) \vert \vert {∇}^{d} ( {z}^{- 1} ) \vert \vert α ( z ) \vert} .$$

The controller is then given by

$$1 ( {z}^{- 1} , z ) = \frac{δ ( {z}^{- 1} ) {α ( {z}^{- 1} )}^{+} {α ( z )}^{T +} {Ω ( z )}^{T} {Q}_{1} γ ( {z}^{- 1} )}{\vert α ( {z}^{- 1} ) \vert \vert φ * ( z ) \vert \vert α ( z ) \vert} .$$

To obtain the controller in an implementable form, we write

$$\begin{matrix}\frac{α ( {z}^{- 1} )}{δ ( {z}^{- 1} )} {u}_{t} = \frac{{α ( z )}^{T +} {Ω ( z )}^{T} {Q}_{1} γ ( {z}^{- 1} )}{\vert φ * ( {z}^{- 1} ) \vert \vert {∇}^{d} ( {z}^{- 1} ) \vert \vert α ( z ) \vert} , \\ = \frac{{α ( z )}^{T +} {Ω ( z )}^{T} {Q}_{1} γ ( {z}^{- 1} )}{\vert φ * ( {z}^{- 1} ) \vert \vert {∇}^{d} ( {z}^{- 1} ) \vert \vert α ( z ) \vert} \frac{{ϑ ( {z}^{- 1} )}^{+} φ * ( {z}^{- 1} ) {∇}^{d} ( {z}^{- 1} )}{\vert ϑ ( {z}^{- 1} ) \vert} {y}_{t}^{sp} , \\ = \frac{{β}_{2} ( {z}^{- 1} )}{\vert ϑ ( {z}^{- 1} ) \vert \vert φ * ( {z}^{- 1} ) \vert \vert {∇}^{d} ( {z}^{- 1} ) \vert} {y}_{t}^{sp} + \frac{{{ζ}_{2} ( z )}^{T}}{\vert α ( z ) \vert} {zy}_{t}^{sp} , \\ = \frac{{β}_{2} ( {z}^{- 1} )}{\vert ϑ ( {z}^{- 1} ) \vert \vert φ * ( {z}^{- 1} ) \vert \vert {∇}^{d} ( {z}^{- 1} ) \vert} [ {\hat{y}}_{t} + {y}_{t} ] + {v}_{t} .\end{matrix}$$

By replacing the variable ŷₜ for the variable uₜ and bringing the term associated with this variable to the left hand side of the equation, we can write

$$[ \frac{α ( {z}^{- 1} )}{δ ( {z}^{- 1} )} - \frac{{β}_{2} ( {z}^{- 1} ) Ω ( {z}^{- 1} ) {z}^{- f - 1}}{\vert ϑ * ( {z}^{- 1} ) \vert \vert φ * ( {z}^{- 1} ) \vert \vert {∇}^{d} ( {z}^{- 1} ) \vert δ ( {z}^{- 1} )} ] {u}_{t} = \frac{{β}_{2} ( {z}^{- 1} )}{\vert ϑ ( {z}^{- 1} ) \vert \vert φ * ( {z}^{- 1} ) \vert \vert {∇}^{d} ( {z}^{- 1} ) \vert} {y}_{t} + {v}_{t} .$$

Finally, we can write the controller equation as below
[|ν(z⁻¹)| |φ*(z⁻¹)| |∇^{d}(z⁻¹)|α(z⁻¹)−β₂(z⁻¹)Ω(z⁻¹)z^{-f-1}]uₜ=δ(z⁻¹)β₂(z⁻¹)yₜ+δ(z⁻¹)|ν(z⁻¹)| |φ*(z⁻¹)| |∇^{d}(z⁻¹)|vₜ. (20)

For checking of the model of the system, we can calculate the following quantities for this 2.5-DOF control law. For the input variable, we have

$$\begin{matrix}\vert {∇}^{d} ( {z}^{- 1} ) \vert {u}_{t} = \frac{δ ( {z}^{- 1} ) {α ( {z}^{- 1} )}^{+} {α ( z )}^{+ T} {Ω ( z )}^{T} {Q}_{1} γ ( {z}^{- 1} )}{\vert α ( {z}^{- 1} ) \vert \vert α ( z ) \vert \vert φ * ( {z}^{- 1} ) \vert} {δ}_{t} , \\ = [ \frac{{b}_{u} ( {z}^{- 1} )}{\vert φ * ( {z}^{- 1} ) \vert \vert α ( {z}^{- 1} ) \vert} + \frac{{c}_{u} ( z )}{\vert α ( z ) \vert} z ] {δ}_{t} .\end{matrix}$$

Therefore, we can obtain

$$\begin{matrix}{R}_{\vert {∇}^{d} \vert u , 2.5 - DOF} = {\sum }_{t = - ∞}^{∞} \vert {∇}^{d} ( {z}^{- 1} ) \vert {u}_{t} \vert {∇}^{d} ( {z}^{- 1} ) \vert {u}_{t}^{T} , \\ = {Residue}_{z = 0} \{ \begin{matrix}\frac{{b}_{u} ( z ) {rr}^{T} {{b}_{u} ( {z}^{- 1} )}^{T}}{\vert φ * ( {z}^{- 1} ) \vert \vert α ( z ) \vert \vert φ * ( {z}^{- 1} ) \vert \vert α ( {z}^{- 1} ) \vert} + \\ \frac{{c}_{u} ( z ) {rr}^{T} {{c}_{u} ( {z}^{- 1} )}^{T}}{\vert α ( z ) \vert \vert α ( {z}^{- 1} ) \vert}\end{matrix} \} \frac{1}{z} .\end{matrix} \qquad ( 21 )$$

To calculate a similar quantity for yₜ, we have to find the equation for this error variable first. It can be found that this variable is given as below.

$${y}_{t} = ψ ( {z}^{- 1} ) {δ}_{t} + \frac{γ ( {z}^{- 1} ) - Ω ( {z}^{- 1} ) {α ( {z}^{- 1} )}^{- 1} {α ( z )}^{- T} {Ω ( z )}^{T} {Q}_{1} γ ( {z}^{- 1} )}{\vert φ * ( {z}^{- 1} ) \vert \vert {∇}^{d} ( {z}^{- 1} ) \vert} {z}^{- f - 1} {δ}_{t} .$$

The factor |∇^{d}(z⁻¹) in the denominator will cancel with its counterpart in the numerator of the second term in the expression for yₜ. Therefore, we can write this error variable as shown below

$$\begin{matrix}{y}_{t} = ψ ( {z}^{- 1} ) {δ}_{t} + \frac{δ ( z ) \vert {∇}^{d} ( z ) \vert {\sqrt{{Q}_{1}}}^{- 1} \sqrt{{Q}_{0}} {π ( z )}^{- T} {π ( {z}^{- 1} )}^{- 1} \sqrt{{Q}_{0}} {\sqrt{Q}}_{1} γ ( {z}^{- 1} ) δ ( {z}^{- 1} )}{\vert φ * ( {z}^{- 1} ) \vert} {z}^{- f - 1} {δ}_{t} , \\ = ψ ( {z}^{- 1} ) {δ}_{t} + \frac{δ ( z ) \vert {∇}^{d} ( z ) \vert {\sqrt{{Q}_{1}}}^{- 1} \sqrt{{Q}_{0}} {π ( z )}^{+ T} {π ( {z}^{- 1} )}^{+} \sqrt{{Q}_{0}} {\sqrt{Q}}_{1} γ ( {z}^{- 1} ) δ ( {z}^{- 1} )}{\vert φ * ( {z}^{- 1} ) \vert} {z}^{- f - 1} {δ}_{t} , \\ = ψ ( {z}^{- 1} ) {δ}_{t} + [ \frac{{b}_{y} ( {z}^{- 1} )}{\vert φ * ( {z}^{- 1} ) \vert \vert π ( {z}^{- 1} ) \vert} + \frac{{c}_{y} ( z )}{\vert π ( z ) \vert} z ] {z}^{- f - 1} {δ}_{t} .\end{matrix}$$

With the expression for the error variable obtained, we can have the following equation for this variable.

$$\begin{matrix}{R}_{y , 2.5 - DOF} = {\sum }_{t = - ∞}^{∞} {y}_{t} {y}_{t}^{T} , \\ = {Residue}_{z = 0} \{ \begin{matrix}ψ ( z ) {rr}^{T} {ψ ( {z}^{- 1} )}^{T} + \\ \frac{{b}_{y} ( z ) {rr}^{T} {{b}_{y} ( {z}^{- 1} )}^{T}}{\vert φ * ( {z}^{- 1} ) \vert \vert π ( {z}^{- 1} ) \vert \vert φ * ( {z}^{- 1} ) \vert \vert π ( {z}^{- 1} ) \vert} + \\ \frac{{c}_{y} ( z ) {rr}^{T} {{c}_{y} ( {z}^{- 1} )}^{T}}{\vert π ( z ) \vert \vert π ( {z}^{- 1} ) \vert}\end{matrix} \} \frac{1}{z} .\end{matrix} \qquad ( 22 )$$

3 The Stochastic Regulating Control Systems

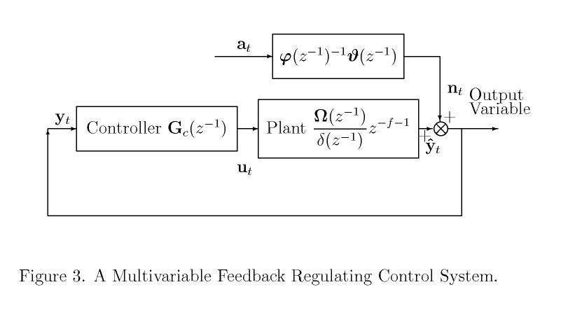

Like the case of tracking control, a regulating control system also has a disturbance. But its disturbance is stochastic rather than deterministic in the sense that it is uncertain and not known in advance. A stochastic regulating control system with its model is depicted in FIG. 3.

3.1 The Disturbance Model

The disturbance model for a stochastic regulating control system is a vector ARIMA time series or a VARIMA. The model for a VARIMA is given as follows:
φ(z⁻¹)nₜ=ν(z⁻¹)aₜ,
φ*(z⁻¹)∇^{d}(z⁻¹)nₜ=ν(z⁻¹)aₜ.

The variable nₜ is a disturbance variable whose driving or input variable is a white noise vector aₜ. Similarly to the tracking control case, the matrix polynomial ∇^{d}(z⁻¹) must be diagonal. But unlike the tracking control case, the stable matrix polynomials φ*(z⁻¹) and ν(z⁻¹) do not have to be diagonal.

3.2 The Stochastic Controllers

There are two stochastic regulating controllers that we can obtain for the above multi-variable stochastic regulating control system. These are the minimum variance and the linear quadratic Gaussian controllers.

3.2.1 The Minimum Variance Controller

From the block diagram of FIG. 3, we can write the (disturbed) output variable as below

$${y}_{t} = \frac{Ω ( {z}^{- 1} )}{δ ( {z}^{- 1} )} {z}^{- f - 1} {u}_{t} + \frac{{[ φ * ( {z}^{- 1} ) {∇}^{d} ( {z}^{- 1} ) ]}^{+} ϑ ( {z}^{- 1} )}{\vert φ * ( {z}^{- 1} ) \vert \vert {∇}^{d} ( {z}^{- 1} ) \vert} ] {a}_{t} . \qquad ( 23 )$$

By using the Diophantine Eq. (4), we can write

$${y}_{t} = ψ ( {z}^{- 1} ) {a}_{t} + [ \frac{Ω ( {z}^{- 1} )}{δ ( {z}^{- 1} )} {u}_{t} + \frac{γ ( {z}^{- 1} )}{\vert φ * ( {z}^{- 1} ) \vert \vert {∇}^{d} ( {z}^{- 1} ) \vert} {a}_{t} ] {z}^{- f - 1} .$$

The minimum variance controller can also be derived from the above equation. From this equation, we can see that the variance of the output variable yₜ is given by two parts. One is independent of the controller and is contributed by feedback and dead time of the system. This part is given by the first term of the right hand side of the above equation. The second part is dependent on the controller. The minimum variance controller is the one that will give this part a value of zero. This controller in terms of the input and output variables can be derived to be given as below.

$$\frac{Ω ( {z}^{- 1} )}{δ ( {z}^{- 1} )} {u}_{t} = - \frac{γ ( {z}^{- 1} )}{\vert φ * ( {z}^{- 1} ) \vert \vert {∇}^{d} ( {z}^{- 1} ) \vert} {a}_{t} .$$

This equation will lead to
|φ*(z⁻¹)| |ψ(z⁻¹)|Ω(z⁻¹)|∇^{d}(z⁻¹)|uₜ=−δ(z⁻¹)γ(z⁻¹)ψ(z⁻¹)⁺yₜ. (24)

The variance matrices R_{|∇}_{^{d}}_{|u,MV} and R_{y,MV} are identical to the matrices of the input and output variables given by Eqs. (8) and (7) except for the term rr^{T} which is replaced by the variance matrix of the white noise R_{α}, ie. we have

$$\begin{matrix}{R}_{\vert {∇}^{d} \vert u , MV} = {Residue}_{z = 0} \frac{δ ( z ) {Ω ( z )}^{+} γ ( z ) {R}_{a} {γ ( {z}^{- 1} )}^{T} {Ω ( {z}^{- 1} )}^{+ T} δ ( {z}^{- 1} )}{z \vert φ * ( z ) \vert \vert Ω ( z ) \vert \vert Ω ( {z}^{- 1} ) \vert \vert φ * ( {z}^{- 1} ) \vert} \\ and & ( 25 ) \\ {R}_{y , MV} = {Residue}_{z = 0} ψ ( z ) {R}_{a} {ψ ( {z}^{- 1} )}^{T} \frac{1}{z} . & ( 26 )\end{matrix}$$

The minimum variance controller—Eq. (24)—differs from that of the minimum prototype tracking controller by a sign. This is due to the fact that for tracking control the feedback signal is inverted whereas in the regulating control case it is not.

3.2.2 The LQG Controller

Like the case of tracking control, a constrained linear quadratic controller whose performance index given below is occasionally the preferred controller

$$\begin{matrix}Min {σ}^{2} = Min tr E \{ {y}_{t + f + 1}^{T} {Q}_{1} {y}_{t + f + 1} + \vert {∇}^{d} \vert {u}_{t}^{T} {Q}_{2} \vert {∇}^{d} \vert {u}_{t} \} , \\ = Min tr [ {Q}_{1} E \{ {y}_{t + f + 1} {y}_{t + f + 1}^{T} \} + {Q}_{2} E \{ \vert {∇}^{d} \vert {u}_{t} \vert {∇}^{d} \vert {u}_{t}^{T} \} ] , \\ = Min tr [ {Q}_{1} {R}_{y} + {Q}_{2} {R}_{\vert {∇}^{d} \vert u} ] .\end{matrix} \qquad ( 27 )$$

The matrices R_{y} and R_{|∇}_{^{d}}_{|u} are the variance matrices of the output and input variables. The choices for the matrices Q₁ and Q₂ are similar to the choices of these matrices for the deterministic tracking control case. To obtain the controller from the above performance index, we use the variance formula for a VARMA time series and obtain the variance for the input variable and output variable as follows.

Assuming that the controller can be written in the following form:
|∇^{d}(z⁻¹)|uₜ=1(z⁻¹)aₜ.

Then by using the formula for the variance matrix of a VARMA time series, we can write the variance matrix for the input variable as below

$$\begin{matrix}{R}_{\vert {∇}^{d} \vert u} = \frac{1}{2 π i} {∮}_{C} 1 ( z ) {R}_{a} 1 {( {z}^{- 1} )}^{T} \frac{dz}{z} , \\ = {Residue}_{z = 0} 1 ( z ) {R}_{a} 1 {( {z}^{- 1} )}^{T} \frac{1}{z} .\end{matrix}$$

Similarly, we can write the variance matrix for the output variable yₜ as below

$${R}_{y} = {Residue}_{z = 0} [ ψ ( z ) + [ \frac{Ω ( z ) 1 ( z )}{δ ( z ) \vert {∇}^{d} ( z ) \vert} + \frac{γ ( z )}{\vert φ * ( z ) \vert \vert {∇}^{d} ( z ) \vert} ] {z}^{f + 1} ] {{R}_{a} [ ψ ( {z}^{- 1} ) + [ \frac{Ω ( {z}^{- 1} ) 1 ( {z}^{- 1} )}{δ ( {z}^{- 1} ) \vert {∇}^{d} ( {z}^{- 1} ) \vert} + \frac{γ ( {z}^{- 1} )}{\vert φ * ( {z}^{- 1} ) \vert \vert {∇}^{d} ( {z}^{- 1} ) \vert} ] {z}^{- f - 1} ]}^{T} \frac{1}{z} .$$

With the above result, we can write the performance index as below

$${σ}^{2} = {Residue}_{z = 0} tr {Q}_{1} [ ψ ( z ) + [ \frac{Ω ( z ) 1 ( z )}{δ ( z ) \vert {∇}^{d} ( z ) \vert} + \frac{γ ( z )}{\vert φ * ( z ) \vert \vert {∇}^{d} ( z ) \vert} ] {z}^{f + 1} ] {{R}_{a} [ ψ ( {z}^{- 1} ) + [ \frac{Ω ( {z}^{- 1} ) 1 ( {z}^{- 1} )}{δ ( {z}^{- 1} ) \vert {∇}^{d} ( {z}^{- 1} ) \vert} + \frac{γ ( {z}^{- 1} )}{\vert φ * ( {z}^{- 1} ) \vert \vert {∇}^{d} ( {z}^{- 1} ) \vert} ] {z}^{- f - 1} ]}^{T} \frac{1}{z} + Residue tr {Q}_{2} 1 ( z ) {R}_{a} 1 {( {z}^{- 1} )}^{T} \frac{1}{z} .$$

Like the case of tracking control, we can manipulate the above equation to obtain the following one:

$${σ}^{2} = {Residue}_{z = 0} tr \{ \begin{matrix}{Q}_{1} ψ ( z ) {R}_{a} {ψ ( {z}^{- 1} )}^{T} + \\ \frac{\begin{matrix}δ ( z ) π ( z ) + \\ \sqrt{{Q}_{0}} \sqrt{{Q}_{1}} γ ( z ) {R}_{a} {γ ( {z}^{- 1} )}^{T} \sqrt{{Q}_{1}} \sqrt{{Q}_{0}} {π ( {z}^{- 1} )}^{T +} δ ( {z}^{- 1} )\end{matrix}}{\vert {φ}^{*} ( z ) \vert \vert π ( z ) \vert \vert {φ}^{*} ( {z}^{- 1} ) \vert \vert π ( {z}^{- 1} ) \vert} + \\ {R}_{a} [ \frac{1 {( {z}^{- 1} )}^{T} {α ( {z}^{- 1} )}^{T}}{δ ( {z}^{- 1} ) \vert {∇}^{d} ( {z}^{- 1} ) \vert} + \frac{{γ ( {z}^{- 1} )}^{T} {Q}_{1} Ω ( z ) {α ( z )}^{+}}{\vert {φ}^{*} ( {z}^{- 1} ) \vert \vert {∇}^{d} ( {z}^{- 1} ) \vert \vert α ( z ) \vert} ] \\ [ \frac{α ( z ) 1 ( z )}{δ ( z ) \vert {∇}^{d} ( z ) \vert} + \frac{{α ( {z}^{- 1} )}^{T +} {Ω ( {z}^{- 1} )}^{T} {Q}_{1} γ ( z )}{\vert α ( {z}^{- 1} ) \vert \vert {φ}^{*} ( z ) \vert \vert {∇}^{d} ( z ) \vert} ]\end{matrix} \} \frac{1}{z} . \qquad ( 28 )$$

In this case, we cannot have the 2.5-DOF controller, since we do not have the future white noise values. Therefore, we can only obtain one linear quadratic controller. This controller can be obtained as follows. First we define the following Diophantine equation:

$$\frac{{γ ( {z}^{- 1} )}^{T} {Q}_{1} Ω ( z ) {α ( z )}^{+}}{\vert {φ}^{*} ( {z}^{- 1} ) \vert \vert {∇}^{d} ( {z}^{- 1} ) \vert \vert α ( z ) \vert} = \frac{{β ( {z}^{- 1} )}^{T}}{\vert {φ}^{*} ( {z}^{- 1} ) \vert \vert {∇}^{d} ( {z}^{- 1} ) \vert} + \frac{ζ ( z )}{\vert α ( z ) \vert} z \qquad ( 29 )$$

and write Eq. (28) as below

$${σ}^{2} = {Residue}_{z = 0} tr \{ \begin{matrix}{Q}_{1} ψ ( z ) {R}_{a} {ψ ( {z}^{- 1} )}^{T} + \\ \frac{\begin{matrix}δ ( z ) π ( z ) + \\ \sqrt{{Q}_{0}} \sqrt{{Q}_{1}} γ ( z ) {R}_{a} {γ ( {z}^{- 1} )}^{T} \sqrt{{Q}_{1}} \sqrt{{Q}_{0}} {π ( {z}^{- 1} )}^{{T}^{+}} δ ( {z}^{- 1} )\end{matrix}}{\vert {φ}^{*} ( z ) \vert \vert π ( z ) \vert \vert {φ}^{*} ( {z}^{- 1} ) \vert \vert π ( {z}^{- 1} ) \vert} + \\ {R}_{a} [ \frac{1 {( {z}^{- 1} )}^{T} {α ( {z}^{- 1} )}^{T}}{δ ( {z}^{- 1} ) \vert {∇}^{d} ( {z}^{- 1} ) \vert} + \frac{{β ( {z}^{- 1} )}^{T}}{\vert {φ}^{*} ( {z}^{- 1} ) \vert \vert {∇}^{d} ( {z}^{- 1} ) \vert} + \frac{ζ ( z )}{\vert α ( z ) \vert} z ] \\ [ \frac{α ( z ) 1 ( z )}{δ ( z ) \vert {∇}^{d} ( z ) \vert} + \frac{β ( z )}{\vert {φ}^{*} ( z ) \vert \vert {∇}^{d} ( z ) \vert} + \frac{{ζ ( {z}^{- 1} )}^{T}}{\vert α ( {z}^{- 1} ) \vert} {z}^{- 1} ]\end{matrix} \} \frac{1}{z} .$$

Therefore, we can obtain the optimal performance index of the linear quadratic Gaussian controller as below

$${\hat{σ}}_{LQG}^{2} = {Residue}_{z = 0} tr \{ \begin{matrix}{Q}_{1} ψ ( z ) {R}_{a} {ψ ( {z}^{- 1} )}^{T} + \frac{{ζ ( z )}^{T} {R}_{a} ζ ( {z}^{- 1} )}{\vert α ( z ) \vert \vert α ( {z}^{- 1} ) \vert} + \\ \frac{\begin{matrix}δ ( z ) π ( z ) + \\ \sqrt{{Q}_{0}} \sqrt{{Q}_{1}} γ ( z ) {R}_{a} {γ ( {z}^{- 1} )}^{T} \sqrt{{Q}_{1}} \sqrt{{Q}_{0}} {π ( {z}^{- 1} )}^{T +} δ ( {z}^{- 1} )\end{matrix}}{\vert {φ}^{*} ( z ) \vert \vert π ( z ) \vert \vert {φ}^{*} ( {z}^{- 1} ) \vert \vert π ( {z}^{- 1} ) \vert}\end{matrix} \} \frac{1}{z} \qquad ( 30 )$$

with the setting of the controller as follows:

$$\frac{1 {( {z}^{- 1} )}^{T} {α ( {z}^{- 1} )}^{T}}{δ ( {z}^{- 1} ) \vert {∇}^{d} ( {z}^{- 1} ) \vert} = - \frac{{β ( {z}^{- 1} )}^{T}}{\vert {φ}^{*} ( {z}^{- 1} ) \vert \vert {∇}^{d} ( {z}^{- 1} ) \vert}$$

$$or$$

$$\begin{matrix}\frac{α ( {z}^{- 1} ) 1 ( {z}^{- 1} )}{δ ( {z}^{- 1} ) \vert {∇}^{d} ( {z}^{- 1} ) \vert} = - \frac{β ( {z}^{- 1} )}{\vert {φ}^{*} ( {z}^{- 1} ) \vert \vert {∇}^{d} ( {z}^{- 1} ) \vert} , \\ 1 ( {z}^{- 1} ) = - \frac{δ ( {z}^{- 1} ) {α ( {z}^{- 1} )}^{+} β ( {z}^{- 1} )}{\vert α ( {z}^{- 1} ) \vert \vert {φ}^{*} ( {z}^{- 1} ) \vert} , \\ \vert {∇}^{d} ( {z}^{- 1} ) \vert {u}_{t} = - \frac{δ ( {z}^{- 1} ) {α ( {z}^{- 1} )}^{+} β ( {z}^{- 1} )}{\vert α ( {z}^{- 1} ) \vert \vert {φ}^{*} ( {z}^{- 1} ) \vert} {a}_{t} .\end{matrix}$$

Therefore, we have the variance matrix for the input variable as

$${R}_{\vert {∇}^{d} \vert u , LQG} = {Residue}_{z = 0} \frac{δ ( z ) {α ( z )}^{+} β ( z ) {R}_{a} {β ( {z}^{- 1} )}^{T} {α ( {z}^{- 1} )}^{{+}^{T}} δ ( {z}^{- 1} )}{z \vert α ( z ) \vert \vert {φ}^{*} ( z ) \vert \vert α ( {z}^{- 1} ) \vert \vert {φ}^{*} ( {z}^{- 1} ) \vert} . \qquad ( 31 )$$

Similarly to the tracking control case, we can write the disturbed output variable as

$$\begin{matrix}{y}_{t} = ψ ( {z}^{- 1} ) {a}_{t} + \frac{\vert α ( {z}^{- 1} ) \vert γ ( {z}^{- 1} ) - Ω ( {z}^{- 1} ) {α ( {z}^{- 1} )}^{+} β ( {z}^{- 1} )}{\vert α ( {z}^{- 1} ) \vert \vert {φ}^{*} ( {z}^{- 1} ) \vert \vert {∇}^{d} ( {z}^{- 1} ) \vert} {z}^{- f - 1} {a}_{t} , \\ = ψ ( {z}^{- 1} ) {a}_{t} + \frac{\vert {∇}^{d} ( {z}^{- 1} ) \vert η ( {z}^{- 1} )}{\vert α ( {z}^{- 1} ) \vert \vert {φ}^{*} ( {z}^{- 1} ) \vert \vert {∇}^{d} ( {z}^{- 1} ) \vert} {z}^{- f - 1} {a}_{t} .\end{matrix}$$

Therefore, we can obtain the variance matrix for this disturbed output variable as below:

$${R}_{y , LQG} = {Residue}_{z = 0} \{ ψ ( z ) {R}_{a} {ψ ( {z}^{- 1} )}^{T} + \frac{η ( z ) {R}_{a} {η ( {z}^{- 1} )}^{T}}{\vert α ( z ) \vert \vert {φ}^{*} ( z ) \vert \vert α ( {z}^{- 1} ) \vert \vert {φ}^{*} ( {z}^{- 1} ) \vert} \} \frac{1}{z} . \qquad ( 32 )$$

The controller in terms of the input and output variables can be derived to be given as below.
[|ν(z⁻¹)| |φ*(z⁻¹)| |∇^{d}(z⁻¹)|α(z⁻¹)−β(z⁻¹)ν(z⁻¹)⁺φ*(z⁻¹)∇^{d}(z⁻¹)Ω(z⁻¹)z^{-f-1}]uₜ=−δ(z⁻¹)β(z⁻¹)ν(z⁻¹)¹φ*(z⁻¹)∇^{d}(z⁻¹)yₜ. (33)

4 Methods of Implementation

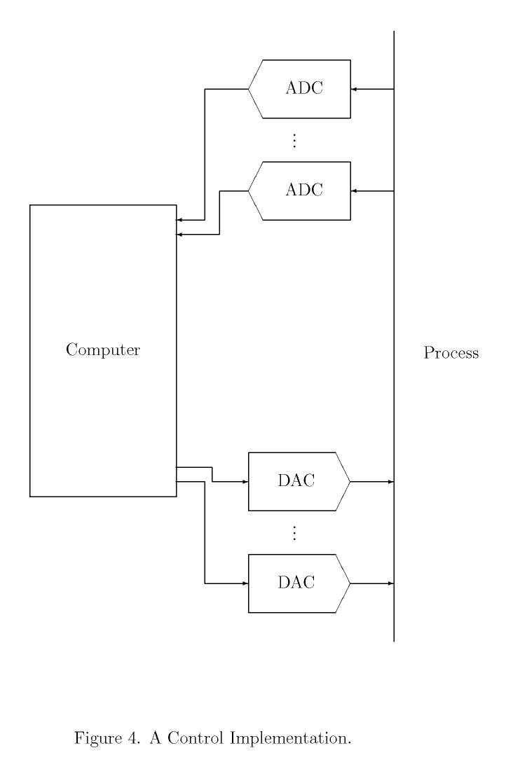

The discussed controllers can be implemented in two ways. For plant or big machine controls, implementation can be carried out with computing devices like a personal computer. For small environment applications, implementation can be done with a single computer chip. The heart of the implementation is a piece of software code that does the computation. The incoming signal must be digitized with Analog-to-Digital Converters (ADCs), but the control signals can be either analog or digital. When they must be analog, the signals are converted by Digital-to-Analog Converters (DACs). The set point values can be generated internally. A typical implementation can be found in FIG. 4.

5 Conclusion

In this application, we have presented a number of controllers for a multivariable discrete rational transfer function. The model with the appropriate disturbance gives different but similar controllers for tracking and regulating controls. The controllers are similar if they have the same disturbance model. In this case the controllers are only different with a sign applied on the output variable. This is due to the fact that in tracking control, the feedback signal is negated before entering the controller. For tracking control, the two and a half degrees of freedom controller is usually the better controller than the one degree of freedom controller. Actually, the name of this controller should not be the two and a half degrees of freedom but the feedforward-feedback controller. The signal vₜ in Eq. (20) comes from the feedforward path and the signal yₜ comes from the feedback path. The name comes from textbooks. Mosca, E. (1995) (Optimal, Predictive, and Adaptive Control. Prentice Hall, Englewood Cliffs, N.J., USA., ISBN 0-138-47609-8) called similar controllers the two degrees of freedom controllers; but Grimble, M. J. (1994) (Robust Industrial Control: Optimal Design Approach for Polynomial Systems. Prentice-Hall International Ltd., UK., ISBN 0-136-55283-8) named them the two and a half degrees of freedom controllers.

What I claim as my invention is:

1. A model and method to generate the future set point values yₜ^{sp} for a multivariable tracking control system.

2. A method to obtain the parameters of the minimum prototype output deadbeat controller for a tracking control system.

3. An on-line method to verify the design model of a tracking control system with the plant model of the physical equipment by calculating the sum of squared values of the input variable |∇^{d}|uₜ obtained from a measurement sensor and comparing that with the quantity R_{|∇u|,MP}, if the tracking control system is under feedback with the minimum prototype output deadbeat controller given in claim 2.

4. An on-line method to verify the design model of a tracking control system with the plant model of the physical equipment by calculating the sum of squared values of the error variable yₜ obtained by taking the value ŷₜ from a measurement sensor then subtracting it from the set point value generated in claim 1 (yₜ=yₜ^{sp}−ŷₜ) and comparing that with the quantity R_{y,MP}, if the tracking control system is under feedback with the minimum prototype output deadbeat controller given in claim 2.

5. A method to obtain the parameters of the 1-DOF linear quadratic controller.

6. A method to verify the 1-DOF controller of a tracking control system by comparing the performance index value of the 1-DOF controller given by the quantity \hat{σ}_{1-DOF}² and the sum of the quantities tr(Q₁R_{y,1-DOF}) and tr(Q₂R_{|∇}_{^{d}}_{|u,1-DOF}).

7. An on-line method to verify the design model of a tracking control system with the plant model of the physical equipment by calculating the sum of squared values of the input variable |∇^{d}|uₜ obtained from a measurement sensor and comparing that with the quantity R_{|∇}_{^{d}}_{|u,1-DOF}, if the tracking control system is under feedback with the 1-DOF controller given in claim 5.

8. An on-line method to verify the design model of a tracking control system with the plant model of the physical equipment by calculating the sum of squared values of the error variable yₜ obtained by taking the value ŷₜ from a measurement sensor then subtracting it from the set point value generated in claim 1 (yₜ yₜ^{sp}−ŷₜ) and comparing that with the quantity R_{y,1-DOF}, if the tracking control system is under feedback with the 1-DOF controller given in claim 5.

9. A method to obtain the parameters of the 2.5-DOF linear quadratic controller.

10. A method to verify the 2.5-DOF controller of a tracking control system by comparing the performance index value of the 2.5-DOF controller given by the quantity \hat{σ}_{2.5-DOF}² and the sum of the quantities tr(Q₁R_{y,2.5-DOF}) and tr(Q₂R_{|∇}_{^{d}}_{|,2.5-DOF}).

11. An on-line method to verify the design model of a tracking control system with the plant model of the physical equipment by calculating the sum of squared values of the input variable |∇^{d}|uₜ obtained from a measurement sensor and comparing that with the quantity R_{|∇}_{^{d}}_{|u,2.5-DOF}, if the tracking control system is under feedback with the 2.5-DOF controller given in claim 9.

12. An on-line method to verify the design model of a tracking control system with the plant model of the physical equipment by calculating the sum of squared values of the error variable yₜ obtained by taking the value ŷₜ from a measurement sensor then subtracting it from the set point value generated in claim 1 (yₜ=yₜ^{sp}−ŷₜ) and comparing that with the quantity R_{y,2.5-DOF}, if the tracking control system is under feedback with the 2.5-DOF controller given in claim 9.

13. A method to obtain the parameters of the minimum variance (MV) controller for a regulating control system disturbed by a VARIMA time series.

14. An on-line method to verify the plant and disturbance models of a stochastic regulating control system by calculating the variance of the input variable |∇^{d}|uₜ obtained from a measurement sensor and comparing that with the quantity R_{|∇}_{^{d}}_{|u,MV}, if the regulating control system is under feedback with the MV controller given in claim 13.

15. An on-line method to verify the plant and disturbance models of a stochastic regulating control system by calculating the variance of the output variable yₜ obtained from a measurement sensor and comparing that with the quantity R_{y,MV}, if the regulating control system is under feedback with the MV controller given in claim 13.

16. A method to obtain the parameters of the LQG controller for a regulating control system disturbed by a VARIMA time series.

17. A method to verify the LQG controller of a regulating control system by comparing the performance index value of this controller given by the quantity \hat{σ}_{LQG}² and the sum of the quantities tr(Q₁R_{y,LQG}) and tr(Q₂R_{|∇}_{^{d}}_{|u,LQG}).

18. An on-line method to verify the plant and disturbance models of a stochastic regulating control system by calculating the variance of the input variable |∇^{d}|uₜ obtained from a measurement sensor and comparing that with the quantity R_{|∇}_{^{d}}_{|u,LQG}, if the regulating control system is under feedback with the LQG controller given in claim 16.

19. An on-line method to verify the plant and disturbance models of a stochastic regulating control system by calculating the variance of the output variable yₜ obtained from a measurement sensor and comparing that with the quantity R_{y,LQG}, if the regulating control system is under feedback with the LQG controller given in claim 16.
